(19) United States
(12) Patent Application Publication
(10) Pub. No.: US 2006/0066485 A1
(43) Pub. Date: Mar. 30, 2006

(54) Wireless tracking system based upon phase differences

(76) Inventor: Guohua Min, Danvers, MA (US)

Correspondence Address: GIFFORD, KRASS, GROH, SPRINKLE & CITKOWSKI, P.C, PO BOX 7021, TROY, MI, 48007-7021, US

(21) Appl. No.: 11/234,896

(22) Filed: Sep. 26, 2005

Related U.S. Application Data
(60) Provisional application No. 60/612,942, filed on Sep. 24, 2004.

(51) Int. Cl. G01S 3/02

(52) U.S. Cl. 342/465

(57) ABSTRACT

A system and method of obtaining high accuracy position information relating to one or more mobile transmitters within a wireless tracking system relies upon phase differences for the time difference of arrival measurements of the transmitter(s). One or more transmitters send signals to multiple receivers, and the time difference of arrival of the transmitter(s) radio signals received at each receiver is used to determine the physical location of the transmitter(s). The high accuracy of the system is obtained through a process of using the transmitter(s)' signals' phase as a reference for time measurements. Since electromagnetic waves travel at the speed of light, knowing how long it takes for a wave to travel from the transmitter to the receiver stations enables a central station to determine the distances the receiver stations are from the transmitter. With predetermined receiver station coordinates, the coordinate of an object embedded with, or carrying, the transmitter can be determined.

### REFERENCE TO RELATED APPLICATION

This application claims priority from U.S. Provisional Patent Application Ser. No. 60/612,942, filed Sep. 24, 2004, the entire content of which is incorporated herein by reference.

### FIELD OF THE INVENTION

This invention relates generally to wireless tracking systems and, in particular, to a wireless tracking system that uses phase differences.

### BACKGROUND OF THE INVENTION

In many applications it is desirable to track, in a non-contact manner, the position of an object as it moves through 3-dimensional space. One method of accomplishing this is to embed an RF transmitter in the object to be tracked. Multiple RF receivers, positioned at known locations, capture the transmitted signal from the object to be tracked. Because the RF energy propagates at a known velocity, the differences in arrival time of the signal at any one pair of the receivers can be used to determine the possible positions of the tracked object in two dimensions.

If the above is carried out using several pairs of receivers, the object's position can be determined in three dimensions. A minimal setup for 3D object tracking utilizes four receivers, one that serves as a common reference for each of the other three receivers. By measuring the time difference of arrival of the signal at each of these three pairs, the resulting system of 3 equations and 3 unknowns (x, y, z coordinates) can be solved and the object's position determined.

Several deficiencies may occur with this type of system. For one, relying only on the time of arrival of the signal itself, without regard to details of the received signal(s) may limit resolution. Accordingly, it is desirable to develop apparatus methods to enhance system accuracy.

### SUMMARY OF THE INVENTION

This invention resides in a method of obtaining high accuracy position information relating to one or more mobile transmitters within a wireless tracking system using phase differences for the time difference of arrival measurements of the transmitter(s). In the preferred embodiment, one or more transmitters send signals to multiple receivers, and the time difference of arrival of the transmitter(s) radio signals received at each receiver is used to determine the physical location of the transmitter(s). The high accuracy of the system is obtained through a process of using the transmitter(s)' signals' phase as a reference for time measurements.

Since electromagnetic waves travel at the speed of light, knowing how long it takes for a wave to travel from the transmitter to the receiver stations enables a central station to determine the distances the receiver stations are from the transmitter. With predetermined receiver station coordinates, the coordinate of an object embedded with, or carrying, the transmitter can be determined.

In one disclosed configuration, a transmitter, four receiver stations, a central station and a computer are employed. The computer is equipped with inventive phase-detection software that enables the system to capture time differences in received signals from the transmitter(s) with much higher accuracy than can be obtained through simple matched filter techniques using pseudo-noise signals or through correlative pulses that use a comparative clock for synchronization.

### BRIEF DESCRIPTION OF THE DRAWINGS

FIG. 1 is a block diagram showing a millimeter-level position localizer system of the prevent intention;

FIG. 2 shows the possible set of phase difference pairs for four relay stations;

FIG. 3 is a block diagram of the transmitter carried on or embedded in the stationary/moving object and the active antenna in each of a plurality of relay station within the localizer system of the prevent invention;

FIG. 4 is the block diagram of the central station in the localizer system of the prevent invention in a general embodiment;

FIG. 5 is the block diagram of the central station in the localizer system of the prevent invention in an improved embodiment;

FIG. 6 is the pulse wave of the transmitter and the pulses sequence of the central station in a general embodiment;

FIG. 7 is the pulses sequence of the central station in an improved embodiment;

FIG. 8 is the circuit diagram of the pulse recovery and pulse reconstruction within the central station in a general embodiment;

FIG. 9 is the circuit diagram of the pulse recovery and pulse reconstruction within the central station in an improved embodiment; and

FIG. 10 is the block diagram of the future embodiment.

### DETAILED DESCRIPTION OF THE INVENTION

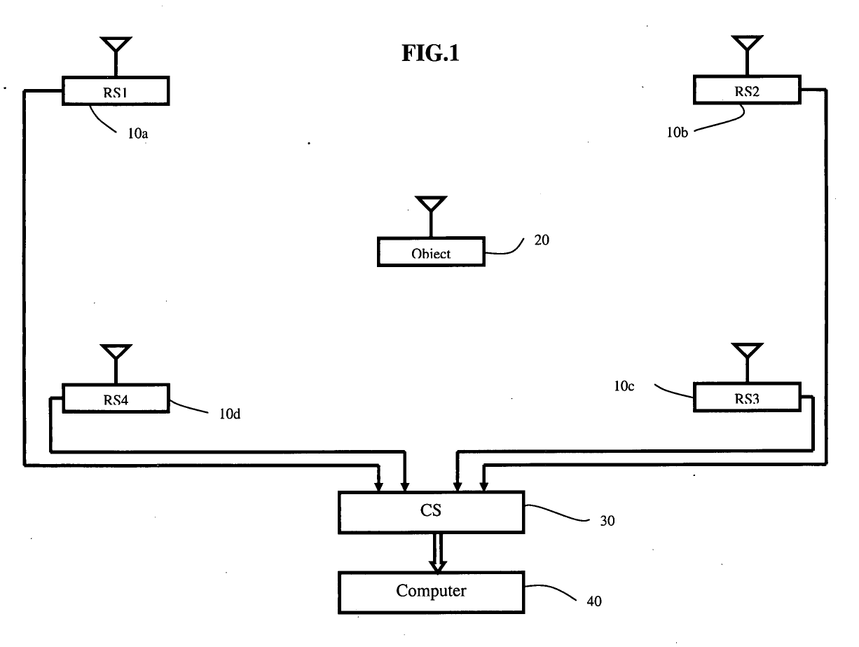

Referring to FIG. 1, therein is illustrated the millimeter position localizer system that includes a plurality of receiver stations (receivers and/or transceivers) 10a through 10d, a transmitter 20 carried on a stationary or moving object of which position is to be determined, a central station 30 to process the Microwave/RF signals, and a computer 40 which includes an interface circuit to calculate the coordinates of the object.

The receiver stations 10a to 10d form a receiver network and the object carrying a transmitter 20 works within that network's physical layout. The transmitter 20 and the receiver stations 10a through 10d are located within sight of each other. Coordinates of each phase center of receiver stations' antenna(s) will be pre-determined and used as physical references for correlating the transmitter(s)' physical location within the receiver station network. Also, the transmitter(s)' antenna(s)' phase center is used as a reference for the physical position of the transmitter.

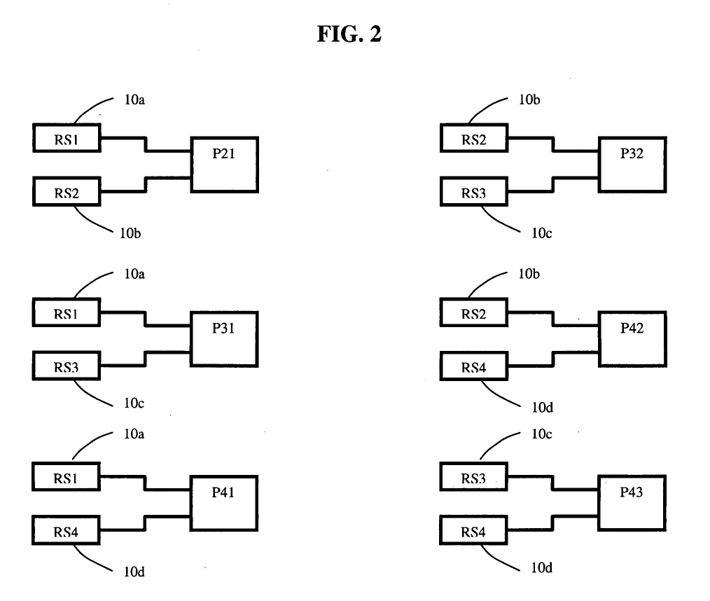

In this localizer system, the transmitter 20 carried on or embedded within the object continuously transmits pulsed or a continuous electromagnetic wave signal, and the receiver stations 10a through 10d receive that signal, and then send this signal to central station 30 via cables. In the central station, a phase discriminator(s) is used to provide phase differences between two signals from a pair of receiver stations. The central station 30 uses the phase differences from each possible pair of the receiver stations (FIG. 2) to obtain the position of the transmitter(s). By comparing each pair's phase differences and correlating these phase differences into time differences, the central station 30 calculates the physical position of the transmitter(s).

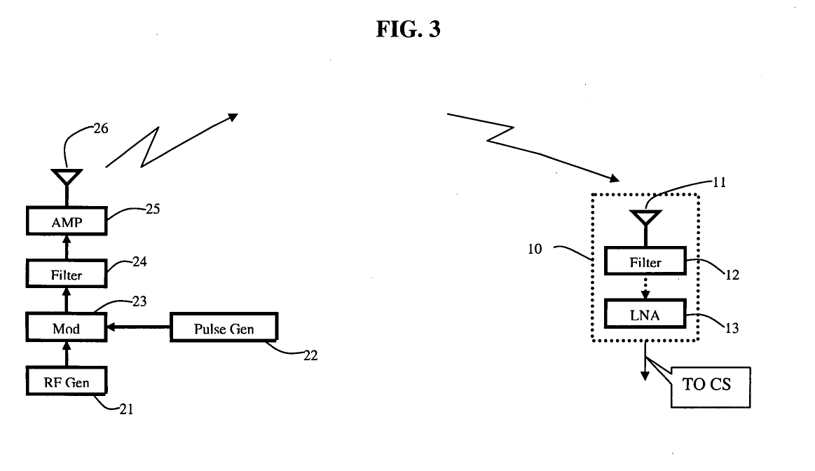

FIG. 3 shows the construction of a receiver station 10 and the construction of a transmitter 20 carried on the object. The transmitter 20 of this embodiment includes a microwave/RF generator 21, a pulse generator 22, a modulator 23, a bandpass filter 24, and a power amplifier 25, an antenna 26. The receiver station 10 includes an antenna 11, and a band pass filter 12, a Low Noise Amplifier (LAN) 13.

The microwave/RF generator 21 within a transmitter 20 carried on or embedded in the object generates a continuous microwave/RF signal. Though any frequency can be chosen the preferred ranges for this system are 5.8 GHz and 2.4 GHz. The pulse generator 22 within a transmitter 20 generates a periodical pulse signal. The modulator 23 herein is a switch controlled by the pulse signal generated by the pulse generator 22. This pulsed microwave/RF signal passes an appropriate band pass filter 24 and power amplifier 25, then is transmitted from the antenna 26.

Each of the receiver stations 10a through 10d works just like an active antenna including an antenna 11 receiving the signal transmitted from the transmitter 20, a band pass filter 12 to reduce the noise and a Low Noise Amplifier (LNA) 13 to amplify the small signal received by the antenna 11.

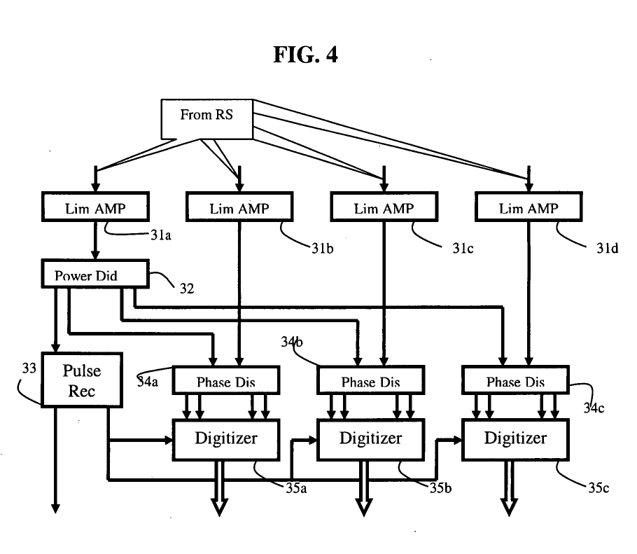

FIG. 4 shows the block diagram of the central station 30 of a first embodiment in which the appropriate pulses and a set of pairs of phase differences will be provided for the calculation of the transmitter's position. Within the central station, there are limited amplifiers 31a through 31d, a power divider 32, a pulse recovery and appropriate pulse generator circuit 33, phase discriminators 34a through 34c, and phase difference digitizers 35a through 35c.

The limited amplifier is to limit the amplitude of the pulsed microwave/RF signal coupled from the receiver station 10. The phase discriminator 34 is the device to discriminate the phase difference between two input signals. It will output the analog signal indicating the phase difference between two input signals. The phase difference digitizer 35 is to digitize the input phase difference analog signal into digital signal. These digital signals will be sent to the computer 40 for calculation.

A reference signal is chosen randomly from receiver stations 10a through 10d. In FIG. 4, 10a is the reference path for the phase discriminating. This reference signal passes through the power divider 32. The power divider 32 divides the reference signal into four channels, one is coupled to pulse recovery and pulse generator circuit 33, and others are coupled to the phase discriminators as the reference signals. The pulse recovery and pulse generator circuit 33 recovers the pulse sequence as the pulse sequence generated by the pulse generator 22 in transmitter 20.

In this invention, the three-dimensional coordinate system refers to an initial stationary point of the transmitter as the origin point. In the described system, the initial phase differences of the initial stationary point of the transmitter 20 are the reference phase differences. This method of comparing initial phase differences received at a set of pairs of receiver stations from the transmitter(s) with later (in time) phase difference information received at the receiver stations from the transmitter, whether moving or stationary, allows the system to accurately calculate the transmitter(s)' position within the receiver station network without requiring a clock for synchronizing time differences.

The phase differences enable the system to calculate the traveled time differences from the transmitter(s) to receiver stations with much higher accuracy since phase differences are fractions of the carrier signal wave cycle.

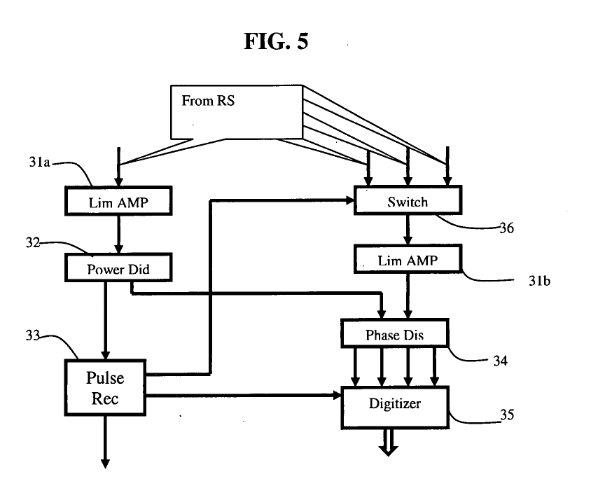

FIG. 5 shows an alternative embodiment of the invention. In this embodiment, just one limited amplifier 31b, one phase discriminator 34 and one digitizer 35 are used to calibrate the errors caused by different limited amplifiers, phase discriminators and digitizers. Switch 36 is employed to separate the signal in different time. The control signal of the switch 36 is generated by the pulse generator circuit 33.

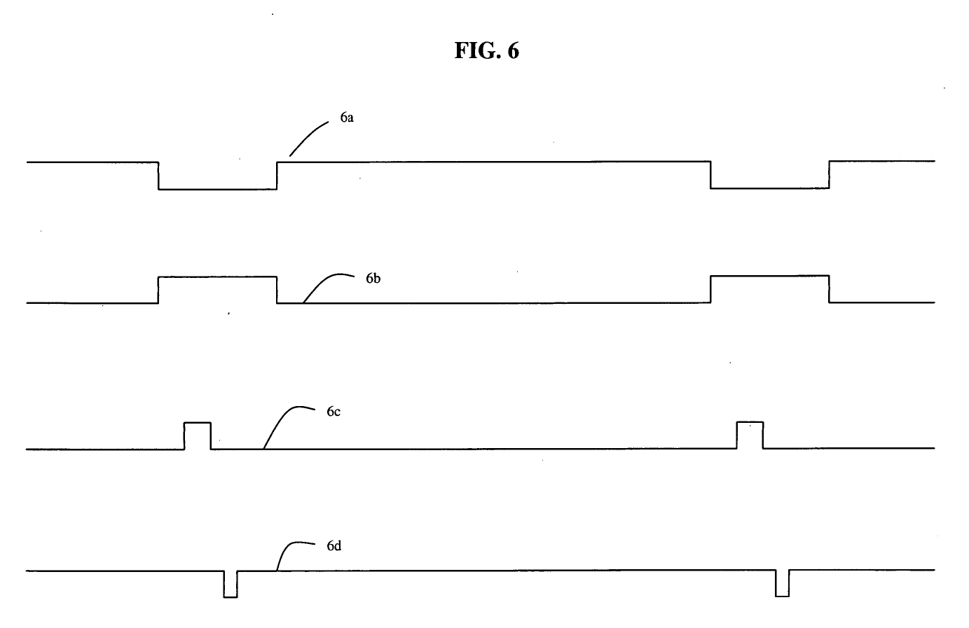

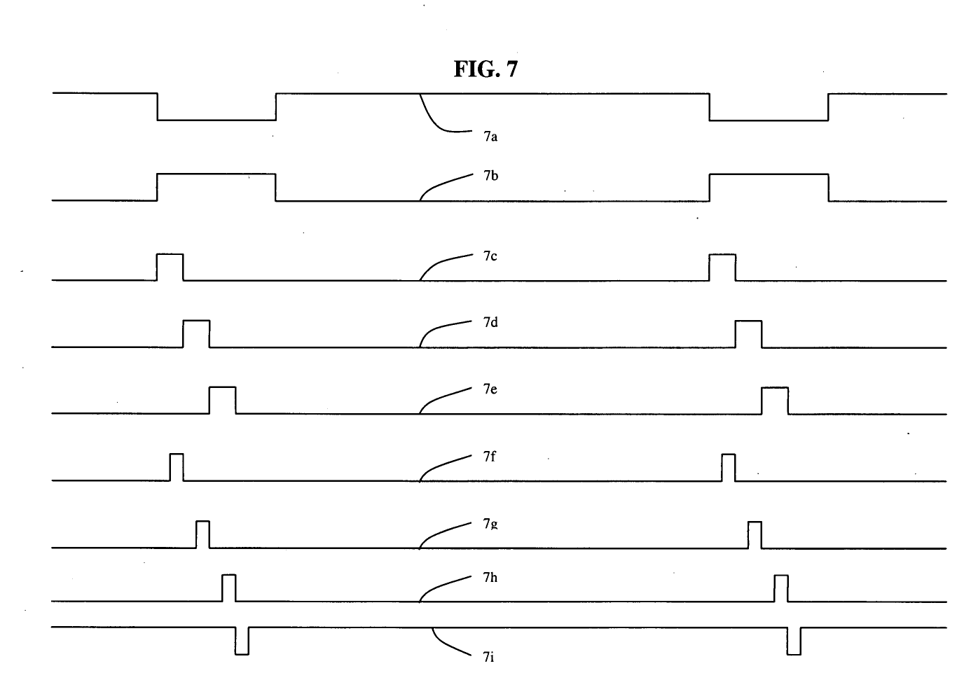

FIGS. 6 and 7 are the pulses' waves generated by pulse generator circuit 33 for the general and improvement embodiment respectively.

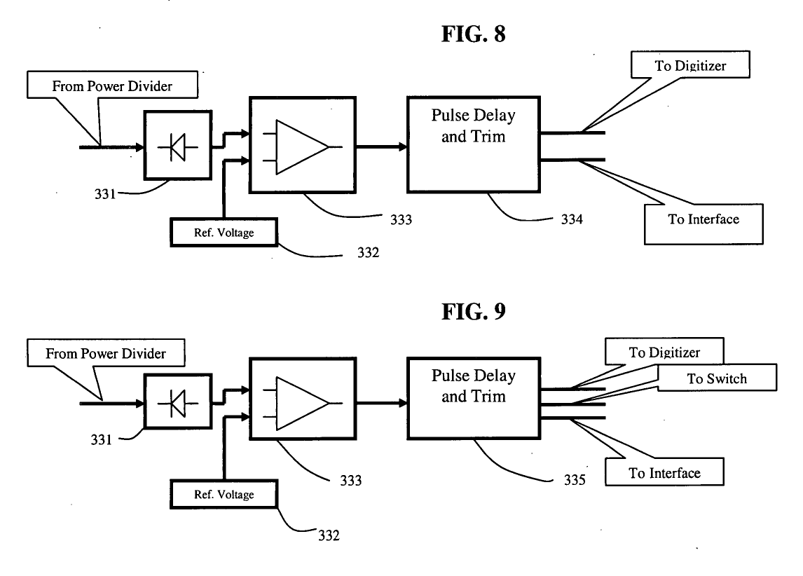

FIGS. 8 and 9 are the circuit diagrams of the pulse generator circuit (33) within the central station in a general and an improved embodiment; A power detector (331), a compare device (333), and pulse delay and trim circuit (334 and 335) are employed. Power detector (331) detects the pulsed microwave signal's power level, showed as wave 6a and 7a in FIG. 6 and FIG. 7, respectively. The compare device (333) compares the detected microwave power level pulse with the reference voltage level and gets the appreciate TTL pulse signal, showed as 6b and 7b in FIGS. 6 and 7, respectively. In a general embodiment, after the pulse delay and trim circuit (334), the wave 6c, going to the digitizers (35), and the wave 6d, going to the interface, will be generated. In an improved embodiment, after the pulse delay and trim circuit (335), the waves 7c, 7d, 7e showed in FIG. 7 going to control the switch (36), and the waves 7f, 7g, 7h, 7i showed in FIG. 7 going to the interface, will be generated.

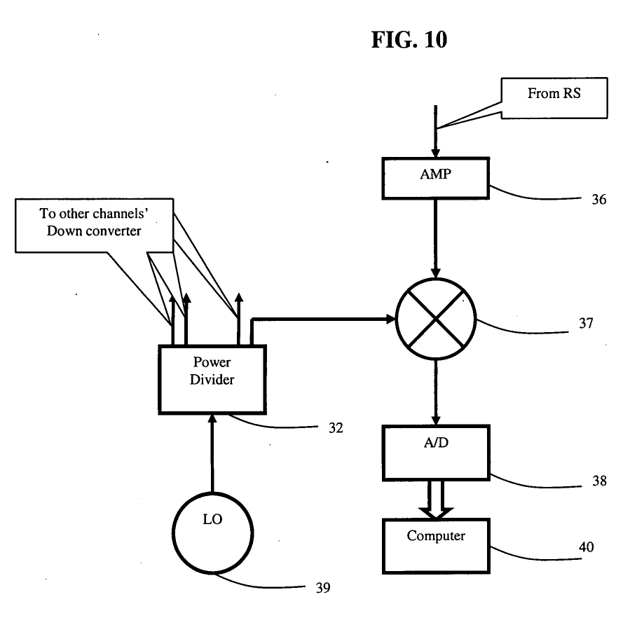

In the described embodiments of the invention, hardware is used to perform the phase discrimination function. Further alternative embodiments eliminate the phase discrimination hardware by performing the phase discrimination function in software. An example of how software can be used for the phase discrimination is shown in FIG. 10. In this system design, a down converter 37, and a local oscillator 39 are added to the central station. The phase discriminators 34 and the digitizers 35 are removed. The down converter 37 (one down converter for every receiver station in the system) changes the signal to a lower carrier frequency with phase difference information that is then converted to digital signal by an Analog to Digital Converter (A/D) 38. This new digital signal provides phase information that is then used by the computer 40 where the phase discrimination function is performed.

I claim:

1. A system for tracking an object, comprising:
at least one transmitter carried on or embedded within at least one object, each transmitter transmitting an electromagnetic signal;
a plurality of receiver stations operative to receive the electromagnetic signal and relay information regarding the signal to a central station; and
at least one phase discriminator in the central station operative to analyze the information from the receiver stations to determine the position of the transmitter and object based upon phase difference.

2. The system of claim 1, wherein the transmitter(s) transmit continuously.

3. The system of claim 1, wherein the receivers send the information to the central station via hardwired connections.

4. The system of claim 1, wherein the phase discriminator(s) compare the information from pairs of receiver stations.

5. The system of claim 1, wherein the central station is operative to correlate phase differences into time differences to determine the physical position of the transmitter(s).
